(19) United States
(12) Patent Application Publication
(10) Pub. No.: US 2025/0154804 A1
(43) Pub. Date: May 15, 2025

(54) ACTUATING APPARATUS FOR A SLIDING DOOR, A SLIDING DOOR ARRANGEMENT FOR A VEHICLE, AND A METHOD FOR ACTUATING A SLIDING DOOR

(71) Applicants: HYUNDAI MOTOR COMPANY, Seoul (KR); KIA CORPORATION, Seoul (KR)

(72) Inventor: Johannes Heichel, Wiesbaden (DE)

(73) Assignees: HYUNDAI MOTOR COMPANY, Seoul (KR); KIA CORPORATION, Seoul (KR)

(21) Appl. No.: 18/733,993

(22) Filed: Jun. 5, 2024

(30) Foreign Application Priority Data
Nov. 13, 2023 (DE) 102023131507.2

(51) Int. Cl. E05B 83/40; E05B 47/00; E05B 81/06; E05B 81/16

(52) U.S. Cl. CPC E05B 83/40; E05B 81/06; E05B 81/16; E05B 2047/002

(57) ABSTRACT

An actuating apparatus for a sliding door comprises: a motor-driven rotating mechanism comprising a driving element arranged to be selectively moved between a first position and a second position upon rotation of the rotating mechanism. The driving element is configured to be selectively coupled with or decoupled from a counter coupling element of the sliding door when in the first position. The driving element is configured to drive the counter coupling element coupled therewith upon rotation of the rotating mechanism at least from the first position to the second position corresponding to a closing position or locking position of the sliding door.

### CROSS-REFERENCE TO RELATED APPLICATION

This application claims priority to and the benefit of German Patent Application No. 102023131507.2, filed on Nov. 13, 2023, the entire contents of which are incorporated herein by reference.

### TECHNICAL FIELD

The present disclosure relates to actuating a sliding door. More particularly, the present disclosure relates to an actuating apparatus for a sliding door, a sliding door arrangement, a vehicle, and a method for actuating a sliding door.

### BACKGROUND

The statements in this section merely provide background information related to the present disclosure and may not constitute prior art.

Sliding doors, which open horizontally by sliding, are used in various fields. For example, in addition to buildings, they are also used in vehicles, such as motor vehicles, buses, trains, and the like.

When a sliding door is to be closed, some effort is required to slide or initiate the movement of the door, e.g. manual operation and/or applying an operating force. For example, a sliding door of a motor vehicle typically may have several solid locks into which the sliding door must be inserted and/or pressed with appropriate force to close it. These locks need to be aligned to each other along with the sliding door at the production of the motor vehicle, require appropriate installation space, and contribute to the overall weight of the sliding door. Generally, regardless of the field of application, closing and/or locking a sliding door typically involves manual operations and/or requires applying an operating force.

### SUMMARY

The present disclosure provides an actuating apparatus for a sliding door, a sliding door arrangement for a vehicle, a method for actuating a sliding door, and a computer program to perform the method.

According to a first aspect, there is provided an actuating apparatus for a sliding door. The actuating apparatus includes a motor-drivable or motor-driven rotating mechanism. The rotating mechanism includes a driving element arranged to be selectively moved between a first position and a second position upon rotation of the rotating mechanism. The driving element is configured to be selectively coupled with or decoupled from a counter coupling element of the sliding door when in the first position. The driving element is configured to drive the counter coupling element coupled therewith upon rotation of the rotating mechanism at least from the first position to the second position corresponding to a closing position and/or locking position of the sliding door.

The proposed actuating apparatus improves the closing and/or locking of a sliding door by using simple structural means. In one embodiment, the actuating apparatus may include a rotating element that can be driven by a motor and includes the driving element. By selectively receiving and/or coupling the counter coupling element by the driving element, the counter coupling element can be easily driven, e.g. moved, carried, or the like, by the driving element along with the rotational movement of the rotating mechanism. For example, the counter coupling element and/or the sliding door may slide over, e.g. within a guiding rail or the like, to the driving element, which in turn drives it by the respective coupling along with the rotational movement of the rotating mechanism to the second position. The second position is the closing position and/or locking position of the sliding door. Due to the rotating mechanism, the rotating mechanism may have compact dimensions and low weight, allowing simple implementation and/or integration thereof in e.g. a vehicle, building, or the like. In case of a motor vehicle, a lock and/or striker at the B-pillar may be omitted. Further, the actuating apparatus does not require electric wiring on a side of the sliding door. The actuating apparatus may be used to securely close and/or lock the sliding door. For example, the actuating apparatus may be used to perform the final movement, e.g. approaching and/or pulling in, of the sliding door to or into an opening of a wall to be closed in a motor-assisted and/or at least semi-automated manner. Thus, manual operations and/or operating forces to be applied for closing and/or locking the sliding door can be at least reduced.

According to an embodiment, the rotating mechanism may be self-locking at least in the second position. For example, the rotating mechanism may include a motor, a driver, or the like, having a self-locking effect. This may provide structural locking of the sliding door in the second position, i.e., the closing position and/or locking position of the sliding door.

In an embodiment, the actuating apparatus may further include a self-locking gearbox coupled to the rotating mechanism. The gearbox may be configured to restrict rotation thereof at least in a direction of the first position. For example, the gearbox may be configured as a worm gear, linear spindle gear, or the like. The gearbox may be coupled to the rotating mechanism via its toothed gears, e.g. via a corresponding toothing with the same. Such a gear has a strong self-locking effect and allows a particularly robust locking of the rotating mechanism and/or its driving element in its second position.

According to an embodiment, the actuating apparatus may include a locking mechanism configured to be selectively coupled to the rotating mechanism in at least the second position to restrict rotation thereof at least in a direction of the first position. The locking mechanism may be provided in addition to any self-locking of the rotating mechanism. The locking mechanism may include at least one mechanical locking element that may be selectively brought into and out of engagement with the rotating mechanism, e.g. a force-locking and/or form-locking manner. Further, the locking mechanism may comprise an actuator coupled to the locking element and configured to move the locking element relative to the rotating mechanism. The actuator may be coupled to at least one of controlling circuitry and a power source. For example, the locking mechanism may be supported by the structural element, e.g. building, vehicle, and the like, whose opening in a wall is to be closed by the sliding door. In case of a vehicle, the locking mechanism may be supported on the vehicle body.

In an embodiment, the actuating apparatus may further include a controlling circuitry. The controlling circuitry may be configured to control at least a motor-driven rotation of the rotating mechanism. For example, the controlling circuitry may include at least one of a data processor, an integrated circuit, a microcontroller, an application-specific integrated circuit (ASIC), a field programmable gate array (FPGA), or the like. The controlling circuitry may be coupled to the rotating mechanism, e.g. its motor. Further, the controlling circuitry may be coupled to a power supply.

According to an embodiment, the controlling circuitry may be configured to receive a first detection signal indicating at least a presence of the counter coupling element at the driving element. The controlling circuitry may be configured to generate, based on the first detection signal, a first control signal configured to control the rotating mechanism to rotate. For example, the actuating apparatus may include or may be coupled to at least one detection device, e.g. sensor or the like, configured to detect at least a presence of the counter coupling element at the driving element. For example, the at least one detection device may include at least one of a magnetic detection sensor, a hall sensor, or the like. The at least one detection device may be arranged at or near the driving element. Upon indication of at least a presence of the counter coupling element at the driving element, the controlling circuitry may cause the rotating mechanism to rotate in a direction of the second position, thereby closing and/or locking the sliding door. Thus, the final movement for closing and/or locking the sliding door can be further automated.

In an embodiment, the controlling circuitry may be configured to receive a second detection signal indicating the driving element has reached the second position. The controlling circuitry may be configured to generate a second control signal configured to control the rotating mechanism to stop rotating. For example, the at least one detection device may include at least one of a magnetic detection sensor, a hall sensor, or the like, configured to detect whether the driving element has reached the second position. Alternatively, the detection may be based on measuring and/or monitoring the electrical power of the motor to determine whether the second position has been reached. Thus, the final movement for closing and/or locking the sliding door can be further automated.

According to an embodiment, the controlling circuitry may be configured to generate a third control signal configured to control a locking mechanism to lock the rotating mechanism to restrict rotational movement thereof. For example, the third control signal may be used to control the above-mentioned locking mechanism, e.g. the actuator, thereof. Thus, the final movement for closing and/or locking the sliding door can be further automated.

In an embodiment, the actuating apparatus may further include at least one detection device configured to detect at least one of a presence of the counter coupling element at the driving element and the driving element at the second position. The at least one detection device may also be configured to detect whether the driving element has reached the second position. For example, the at least one detection device may include at least one of a magnetic detection sensor, a hall sensor, or the like.

According to an embodiment, the driving element may be configured to open towards a peripheral side or outer side of the rotating mechanism when in the first position to selectively receive the counter coupling element for coupling and release the counter coupling element for decoupling. For example, the driving element may be formed as a recess, a groove, or the like. It may be configured that the counter coupling element can be selectively inserted or removed when the driving element is in the first position. For example, in the first position, a guiding rail for guiding the sliding door may open into the driving element, e.g. recess, groove, or the like. This allows the sliding door or its counter coupling element to be slid into the driving element. This may be detected by the at least one detection device, whereupon the rotating mechanism may be controlled to rotate the driving element to the second position.

In an embodiment, the rotating mechanism may include or may be formed by a rotatable gear element drivable by a motor. The gear element may include the driving element at a peripheral section thereof. For example, the gear element may have toothing, e.g. internal toothing or external toothing, via which it may be driven by the motor. Further, by way of example, a gearbox may be arranged to be effective between the motor and the gear element. In such a case, the gearbox may be engaged with the toothing of the gear element. Further, the gearbox may be coupled to the motor via a transmission element, such as a shaft or the like. The gear element allows a robust and compact design.

According to a second aspect, there is provided a sliding door arrangement. The sliding door arrangement includes a sliding door having a counter coupling element. Further, the sliding door arrangement includes an actuating apparatus according to the first aspect.

For example, the sliding door may be used to selectively open and close an opening within a wall of a vehicle, e.g. a motor vehicle, a bus, a train, a building, and the like. The sliding door may be configured to slide horizontally with respect to the wall and/or to slide parallel to the wall. The sliding door includes the counter coupling element. Optionally, the opening within the wall may include at least one sealing to seal the sliding door when closed.

According to an embodiment, the sliding door arrangement may further include a guiding rail configured to guide the sliding door and/or the counter coupling element. The guiding rail may open towards the driving element positioned in the first position. For example, the sliding door may be guided in the guiding rail extending parallel to the wall. As the guiding rail may open towards the driving element, the sliding door can be easily slid along the guiding rail to or into the driving element. For example, in the first position of the driving element, the guiding rail may open into the driving element, e.g. a recess, groove, or the like. This allows the sliding door or its counter coupling element to be slid into the driving element. This may be detected by the at least one detection device, whereupon the rotating mechanism may be controlled to rotate to move the driving element to the second position, thereby closing and/or locking the sliding door.

A third aspect relates to a vehicle including an apparatus according to the first aspect, and/or including a sliding door arrangement according to the second aspect. The vehicle may be any motor vehicle, a train, or the like.

According to a fourth aspect, there is provided a method of actuating a sliding door. The method includes receiving a first detection signal indicating at least a presence of a counter coupling element of a sliding door at a driving element of a rotating mechanism of an actuating apparatus being in a first position. The driving element and the counter coupling element can be selectively coupled with or decoupled from each other. Further, the method includes generating, based on the first detection signal, a first control signal configured to control the rotating mechanism to rotate for moving the driving element and the counter coupling element coupled therewith to a second position corresponding to a closing position and/or locking position of the sliding door.

The method may be applied to the actuation apparatus according to the first aspect or to any other controller of a vehicle configured to control the rotating mechanism. For example, the method may be carried out by the controlling circuitry of the actuation apparatus. This allows for further automating the closing and/or locking of the sliding door.

According to an embodiment, the method may further include receiving a second detection signal indicating that the driving element has reached the second position. The method may further include generating a second control signal configured to control the rotating mechanism to stop rotating. This allows for further automating the closing and/or locking of the sliding door.

In an embodiment, the method may further include generating a third control signal configured to control a locking mechanism to lock the rotating mechanism to restrict rotational movement thereof. This allows for further automating the closing and/or locking of the sliding door.

According to a fifth aspect, there is provided a computer program including instructions to cause the actuation apparatus according to the first aspect to perform the method according to the fourth aspect. The computer program may be stored on a computer-readable medium.

It should be understood that the above aspects and/or embodiments may be combined with each other, unless otherwise indicated.

The disclosure is explained in greater detail with reference to embodiments depicted in the drawings as appended.

### BRIEF DESCRIPTION OF THE DRAWINGS

The accompanying drawings are included to provide a further understanding of the present disclosure and are incorporated in and constitute a part of this specification.

The drawings illustrate the embodiments of the present disclosure and together with the description serve to explain the principles of the disclosure. Other embodiments of the present disclosure and many of the intended advantages of the present disclosure should be readily appreciated as they become better understood by reference to the following detailed description.

The elements of the drawings are not necessarily drawn to scale relative to each other. In the figures, like reference numerals denote like or functionally like components, unless indicated otherwise.

FIG. 1 illustrates, in a schematic top view, an actuating apparatus for a sliding door according to an embodiment.

FIG. 2 illustrates, in a schematic top view, an actuating apparatus for a sliding door according to an embodiment.

FIG. 3 illustrates, in a schematic top view, an actuating apparatus for a sliding door according to an embodiment.

FIG. 4 illustrates, in a schematic top view, an actuating apparatus for a sliding door according to an embodiment.

FIG. 5 illustrates, in a schematic top view, an actuating apparatus for a sliding door according to an embodiment.

FIG. 6 illustrates, in a schematic top view, an actuating apparatus for a sliding door according to an embodiment.

FIG. 7 illustrates, in a schematic top view, an operation of an actuating apparatus for a sliding door according to an embodiment.

FIG. 8 illustrates, in a schematic top view, an operation of an actuating apparatus for a sliding door according to an embodiment.

FIG. 9 illustrates a vehicle comprising a sliding door and an actuating apparatus according to an embodiment.

FIG. 10 illustrates a flowchart describing a method for actuating a sliding door according to an embodiment.

Although specific embodiments are illustrated and described herein, it should be appreciated by those having ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

### DETAILED DESCRIPTION

It should be understood that the actuating apparatus may be used in various fields, in which a sliding door is to be actuated. For example, the actuating apparatus may be used in a vehicle, a building, or the like. As used herein, the terms “vehicle,” “vehicular,” or other similar terms as used herein are inclusive of motor vehicles in general. Such motor vehicles may include sports utility vehicles (SUV), buses, trucks, various commercial vehicles, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, e.g., a vehicle that is both gasoline-powered and electric-powered. Further, the term “vehicle” may include watercraft including a variety of boats and ships, aircraft, trains, and the like.

Further, as used herein, the driving element may be any element, e.g., machine element, machine part, or the like, configured to, when moving, set another part or a workpiece, i.e., the counter coupling element and/or the sliding door coupled therewith, in movement. The driving element may be configured for a force-fit coupling, a form-fit coupling, or a combination of force-fit and form-fit coupling with the counter coupling element. The coupling of the driving element and the counter coupling element with each other may be provided by a coupling mechanism. The coupling can be selectively releasable for decoupling. For example, at least one of the driving element and the counter coupling element may comprise a recess, a groove, a protrusion, a coupling part, or the like that may be selectively coupled, e.g., engaged, with a corresponding counterpart of the other of the driving element and the counter coupling element. Coupling may also be understood as bringing the driving element and the counter coupling element into engagement with each other. Decoupling may also be understood as bringing the driving element and the counter coupling element out of engagement with each other.

Further, as used herein, the first position may correspond to a first angular position related to the rotation of the rotating mechanism. The second position may correspond to a second angular position related to the rotation of the rotating mechanism. The first and second positions may be arranged relative to each other so that the sliding door is moved toward and/or into an opening to be closed by the sliding door via the driving element when the rotating mechanism is rotated in the direction from the first position to the second position. Further, the first position and the second position may be respectively reached by back-and-forth movement, rather than circumferential movement of the rotating mechanism. For example, one of the first position and the second position is reached by a clockwise movement, and the other of the first position and the second position is reached by a counterclockwise movement from the respective other position.

For example, the rotating mechanism may comprise or may be coupled to a motor, e.g. an electric motor or the like, configured to rotate the rotating mechanism. The motor may be coupled to at least one of a controlling circuitry and a power source. For example, the motor may be controllable to cause a back-and-forth movement of the rotating mechanism about a rotational axis of the rotating mechanism. The motor may be controllable, e.g. based on at least one detection signal, to selectively rotate the rotating mechanism, especially when the counter coupling element is coupled with the driving element of the rotating mechanism.

When a controller, component, device, element, part, unit, module, or the like of the present disclosure is described as having a purpose or performing an operation, function, or the like, the component, device, or element should be considered herein as being “configured to” meet that purpose or perform that operation or function. Each controller, component, device, element, part, unit, module, and the like may separately embody or be included with a processor and a memory, such as a non-transitory computer readable media, as part of the apparatus.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for describing relationships between components, such as, “between” and “directly between” or “adjacent to” and “directly adjacent to”, should be interpreted in the same manner.

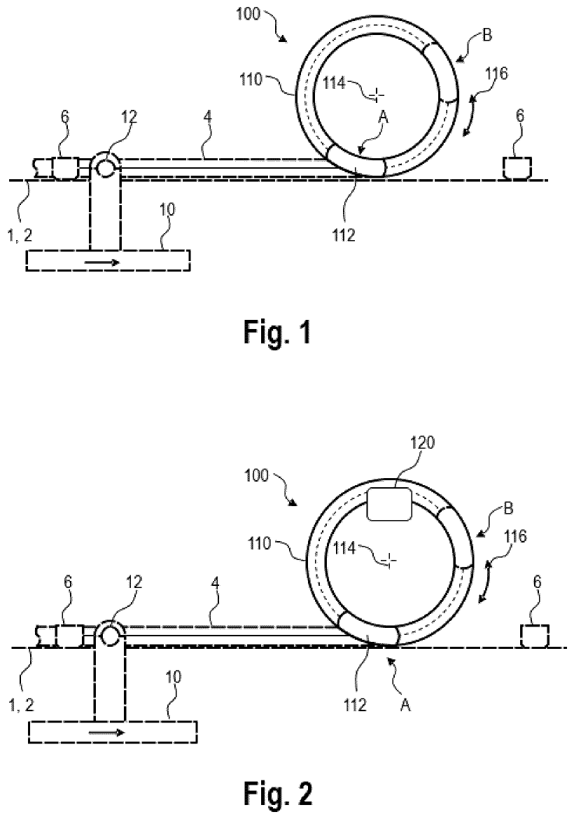

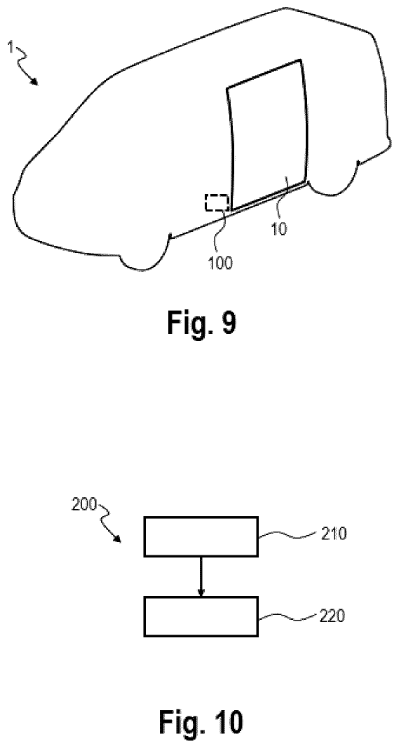

FIG. 1 illustrates, in schematic top view, an actuating apparatus 100 for a sliding door 10. The sliding door 10, which is illustrated by dashed lines, may be used to selectively open and close an opening within a wall 2, which is illustrated by dashed lines of vehicle 1 (illustrated in FIG. 9), a building, or the like. The sliding door 10 may be configured to slide horizontally with respect to the wall 2 and/or to slide parallel to the wall 2. For example, the sliding door 10 may be guided in a guiding rail 4 extending parallel to the wall 2. The sliding door 10 may comprise a counter coupling element 12 configured to be brought in engagement with the guiding rail 4. Alternatively, the opening within the wall 2 may comprise at least one sealing 6 configured to seal with the sliding door 10 when the sliding door 10 is closed.

The actuating apparatus 100 comprises a motor-drivable or motor-driven rotating mechanism 110. The rotating mechanism 110 comprises at least one driving element 112 arranged to be selectively moved between a first position A and a second position B upon rotation of the rotating mechanism 110. By way of example, the rotating mechanism 110 and/or the driving element 112 may rotated around a rotational axis 114. For example, the driving element 112 may be arranged in a peripheral section, in a circumferential section, or the like, of the rotating mechanism 110, e.g. distant to the rotational axis 114. Any section of the rotating mechanism 110 that is moved relative to the opening within the wall 2 in a suitable manner when the rotating mechanism 110 is rotated or pivoted may be used for arranging the driving element 112. At least one of the driving element 112 and the counter coupling element 12 may comprise a recess, a groove, a protrusion, a coupling part, or the like configured to be selectively coupled, e.g. engaged, with a corresponding counterpart of the other of the driving element 112 and the counter coupling element 12.

The driving element 112 is configured to be selectively coupled with or decoupled from the counter coupling element 12 of the sliding door 10 when the driving element 112 is in the first position A. Further, the driving element 112 is configured to drive the counter coupling element 12 coupled therewith, i.e. the counter coupling element 12 coupled with the driving element 112, upon rotation of the rotating mechanism 110, e.g. in a direction along arrow 116, at least from the first position A to the second position B of the rotating mechanism 110. FIG. 1, illustrates the driving element 112 being in the second position B and the driving element 112 being in the first position A. In the first position A, the driving element 112 and the counter coupling element 12 can be selectively coupled with or decoupled from each other. The second position B corresponds to a closing position and/or locking position of the sliding door 10.

In at least some embodiments, the rotating mechanism 110 may be self-locking at least in the second position B. In this case, the driving element 112 and the counter coupling element 12 coupled thereto may be locked in the second position B. As a result in this configuration, locking the sliding door 10 in its closing position closes the opening within the wall 2.

Further, in at least some embodiments, the rotating mechanism 110 may comprise or may be formed by a rotatable gear element. The gear element may comprise the driving element 112 at a peripheral section thereof. Further, by way of example, the gear element may have teeth, e.g. internal toothing or external toothing. The rotating mechanism 110, e.g. gear element, may be arranged such that its rotational axis 114 is aligned perpendicular to the longitudinal extension of the guiding rail 4. In other words, the rotating mechanism 110 may be arranged horizontally. The driving element 112 may be arranged on one end of the face of the rotating mechanism 110.

FIG. 2 illustrates, in a schematic top view, an actuating apparatus 100 according to a further embodiment.

Accordingly, the actuating apparatus 100 and/or the rotating mechanism 110 may comprise and/or may be coupled to a motor 120, e.g. an electric motor or the like, configured to rotate the rotating mechanism 110. The motor 120 may be coupled to a power source (not shown). For example, the motor 120 may be controllable, e.g. by controlling circuitry (controller) of the apparatus 100, the vehicle (1), or any other controlling circuitry, to cause rotation, e.g. a back-and-forth movement about the rotational axis 114 of the rotating mechanism 110, of the rotating mechanism 110.

Further, by way of example, the rotating mechanism 110 may comprise or may be formed by a rotatable gear element drivable by the motor 120. The gear element may comprise the driving element 112 at a peripheral section thereof. Further, by way of example, the gear element may have teeth, e.g. internal toothing or external toothing, via which it may be driven by the motor 120. Accordingly, the motor 120 may have a corresponding toothing or the like.

It is noted that the motor 120 may be self-locking at least in the second position B. Optionally, the motor 120 may comprise or may be coupled to a self-locking gearbox, or the like.

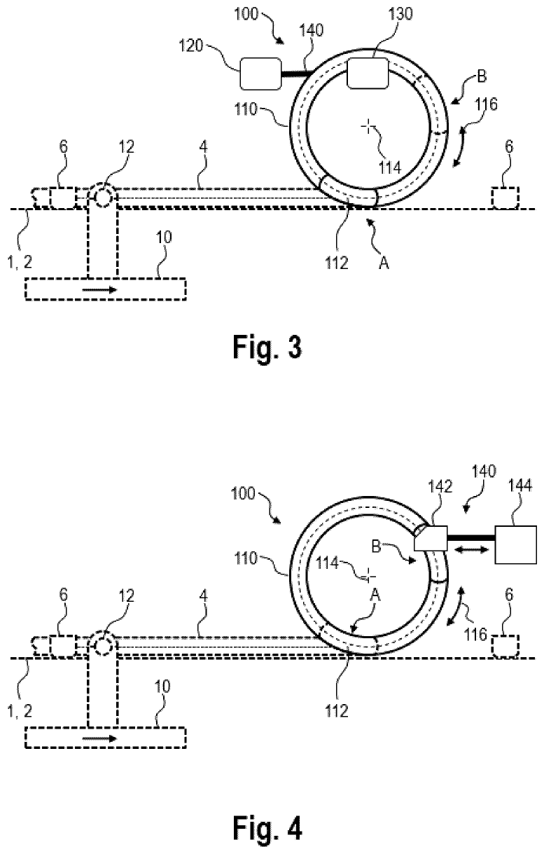

FIG. 3 illustrates, in a schematic top view, an actuating apparatus 100 according to a further embodiment.

The actuating apparatus 100 may comprise a self-locking gearbox 130 coupled to the rotating mechanism 110. The gearbox 130 may be configured to restrict rotation of the rotating mechanism 110 at least the direction of the first position A. For example, the gearbox 130 may be configured as a worm gear, linear spindle gear, or the like. The gearbox 130 may be coupled to the rotating mechanism 110 via its toothed gears. The gearbox 130 may be arranged to be effective between the motor and the rotating mechanism 110, e.g. the gear element. The gearbox 130 may be engaged with the teeth of the gear element. Further, the gearbox 130 and the motor 120 may be coupled to each other via a transmission element 140, such as a shaft or the like.

FIG. 4 illustrates, in a schematic top view, an actuating apparatus 100 according to a further embodiment.

The actuating apparatus 100 may comprise a locking mechanism 140 configured to be selectively coupled to the rotating mechanism 110 in at least the second position B. The locking mechanism 140 may be configured to restrict rotation of the rotating mechanism 110 at least in the direction of the first position A. The locking mechanism 140 may be provided in addition to any self-locking of the rotating mechanism 110. The locking mechanism 140 may comprise at least one mechanical locking element 142 that may be selectively brought into and out of engagement with the rotating mechanism 110, e.g. a force-locking and/or form-locking manner. For example, the locking element 142 may be configured to engage with the driving element 112 when in the second position B. Further, the locking mechanism 140 may comprise an actuator 144 coupled to the locking element 142 and configured to move the locking element 142 relative to the rotating mechanism 110. The actuator 144 may be coupled to at least one of controlling circuitry (not shown) and a power source (not shown). For example, the locking mechanism 140 may be supported by the structural element, e.g. building, vehicle 1, and the like, whose opening within the wall 4 is to be closed by the sliding door. In case of the vehicle 1, the locking mechanism 140 may be supported by e.g. the vehicle body.

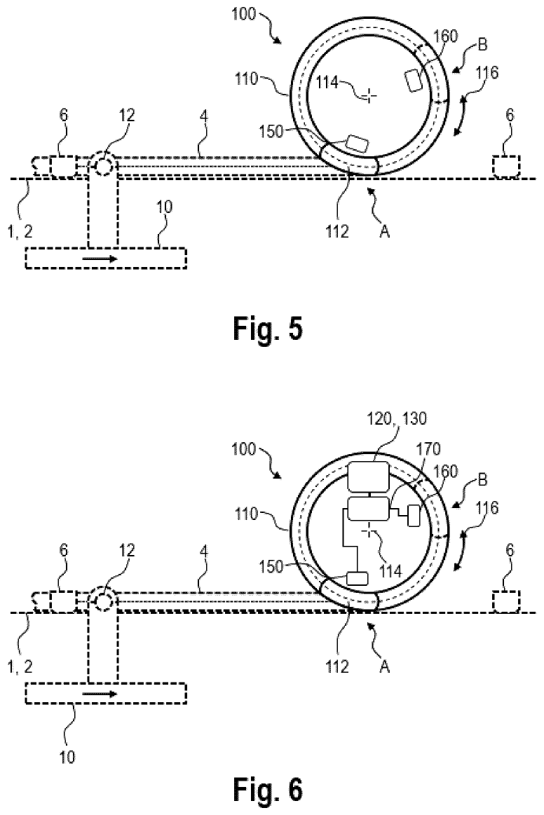

FIG. 5 illustrates, in a schematic top view, an actuating apparatus 100 according to a further embodiment.

The actuating apparatus 100 may comprise or may be coupled to at least one detection device 150, 160, e.g. at least one sensor or the like. Referring to FIG. 5, the actuating apparatus 100 includes two detection devices, a first detection device 150 and a second detection device 160. The first and second detection devices 150 and 160 may be coupled to controlling circuitry, the motor 120, and the like. For example, the first and second detection devices 150 and 160 may comprise at least one of a magnetic detection sensor, a hall sensor, or the like.

The first detection device 150 may be arranged at or near the driving element 112 and/or the first position A. The first detection device 150 may be configured to detect at least the presence of the counter coupling element 12 at the driving element 112. Upon indication of at least the presence of the counter coupling element 12 at the driving element 112 the first detection device 150 may generate and/or provide a corresponding first detection signal to the controlling circuitry or the like. Based on the first detection signal, the rotating mechanism 110 may rotate in the direction of the second position B, thereby closing and/or locking the sliding door 10.

The second detection device 160 may be configured to detect whether driving element 112 has reached the second position B. The second detection device 160 may be configured to generate and/or provide a corresponding second detection signal, or a second control signal, to the controlling circuitry or the like, configured to control the rotating mechanism 110 to stop its rotation. Alternatively, the detection may be based on measuring and/or monitoring the electrical power of the motor 120 to determine whether the second position B has been reached.

FIG. 6 illustrates, in a schematic top view, an actuating apparatus 100 according to a further embodiment.

The actuating apparatus 100 may comprise or may be coupled to controlling circuitry 170 configured to control at least motor-driven rotation of the rotating mechanism 110. It is noted that the controlling circuitry 170 may also be externally provided, e.g. as a controller or the like of the vehicle 1. For example, the controlling circuitry 170 may comprise at least one of a data processor, an integrated circuit, a microcontroller, an application-specific integrated circuit (ASIC), a field programmable gate array (FPGA), or the like. The controlling circuitry 170 may be coupled to the rotating mechanism 110, e.g. its motor 120. Further, the controlling circuitry 170 may be coupled to a power supply (not shown).

The controlling circuitry 170 may be coupled to a power source (not shown), at least one of the motor 120, and the at least one detection device 150, 160.

The controlling circuitry 170 may be configured to receive the above-mentioned first detection signal of the first detection device 150 indicating at least the presence of the counter coupling element 12 at the driving element 112 and/or position A. The controlling circuitry 170 may be configured to generate, based on the first detection signal, a first control signal configured to control the rotating mechanism 110 to rotate. For example, the rotating mechanism 110 may be controlled to selectively move back and forth between the first position A and the second position B.

The controlling circuitry 170 may be configured to receive the above-mentioned second detection signal of the second detection device 160 indicating that the driving element 112 has reached the second position B. The controlling circuitry 170 may be configured to generate, based on the second detection signal, a second control signal configured to control the rotating mechanism 110 to stop its rotation at the second position B.

The controlling circuitry 170 may be configured to generate a third control signal configured to control the locking mechanism 140 to lock the rotating mechanism 110 to restrict rotational movement thereof.

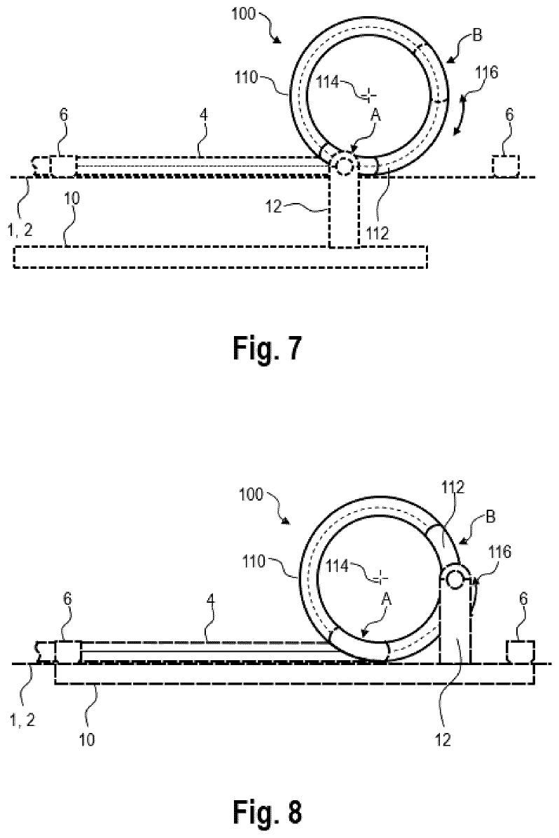

Referring to FIGS. 7 and 8, each figure illustrates a schematic top view of an actuating apparatus 100. Furthermore, each of the figures explains the function and operation of the actuation apparatus 100.

Starting from the opening position of the sliding door 10, in which the opening within the wall 2 is respectively open, as shown in each of FIGS. 1-6, the driving element 112, when in the first position A, may be arranged and/or configured to open to and/or to be aligned with the guiding rail 4. As a result, the configuration allows the driving element 112 and the counter coupling element 12 to be coupled with each other. The driving element 112 may be configured to open towards a peripheral side or outer side of the rotating mechanism 110 when the driving element 112 is in the first position A. This allows the driving element to selectively receive the counter element 12 for coupling and release the counter coupling element 12 for decoupling. For example, the driving element 112 may be formed as a recess, groove, or the like. The driving element 112 may be configured such that the counter coupling element 12 can be selectively inserted or removed from the driving element 112 when the driving element 112 is in the first position A. By way of example, the counter coupling element 12 can be slid towards and/or into the driving element 112 when in the first position A. In the same first position A, the counter coupling element 12 may also slide out from the driving element 12 and slide along the guiding rail, e.g. into the opening position of the sliding door 10 as indicated in FIG. 1.

The sliding door 10 may then be operated, e.g. manually or motor-assisted, to slide along the guiding rail 4. The driving element 112 in the first position A is then arranged at the corresponding end of the guiding rail 4, i.e. at the end of the sliding movement, and opens to the guiding rail 4. Thereby, this arrangement allows the driving element 112 and the counter coupling element 12, to be coupled with each other.

FIG. 7 illustrates the sliding door 10 after the above operation. In other words, FIG. 7 illustrates the sliding door 10 sliding along the guiding rail 4. The driving element 112 and the counter coupling element 12 are coupled with each other.

Referring to FIG. 8, after the driving element 112 and the counter coupling element 12 have been coupled with each other, the rotating mechanism 110 may be controlled to rotate in a counterclockwise direction to move the driving element 112 from the first position A to the second position B. This movement, in turn, drives the counter coupling element 12. Driven by the driving element 112, the counter coupling element 12 and the sliding door 10 coupled thereto move to close the opening of the wall 2. The second position B corresponds to a closing position and/or locking position of the sliding door 10.

It should be understood that moving the driving element 112 back to position A by controlling the rotating mechanism 110 to rotate in a clockwise direction allows the driving element 112 and the counter coupling element 12 to be decoupled from each other again. The sliding door 10 may then be slid within and/or along the guiding rail 4 in the opening position of the sliding door 10.

FIG. 9 schematically illustrates the above-mentioned vehicle 1 comprising the sliding door 10 and the actuation apparatus 100 coupled to each other. The actuation apparatus 100 may be used to close and/or lock the sliding door 10 with respect to the vehicle body, which comprises the above-mentioned wall 2. The sliding door 10 may be guided in the above-mentioned guiding rail 4.

FIG. 10 illustrates a flowchart explaining a method 200 of actuating a sliding door. The method may be applied to the controlling circuitry, the actuation apparatus 100, and the like.

The method 200 comprises receiving 210 a first detection signal indicating at least the presence of a counter coupling element 12 of the sliding door 10 at a driving element 112 of a rotating mechanism 110 being in a first position. The driving element 112 and the counter coupling element 12 can be selectively coupled with or decoupled from each other. The method 200 further comprises generating, based on the first detection signal, a first control signal configured to control the rotating mechanism 110 to rotate for moving the driving element 112 and the counter coupling element 12 coupled therewith to a second position. The second position corresponds to a closing position and/or locking position of the sliding door 10.

In the foregoing detailed description, various features are grouped together in one or more embodiments with the purpose of streamlining the disclosure. It should be understood that the above description is intended to be illustrative, and not restrictive. The above description is intended to cover all alternatives, modifications, and equivalents of the different features and embodiments. Many other embodiments should be apparent to one having ordinary skill in the art upon reviewing the above specification. The embodiments were chosen and described in order to explain the principles of the disclosure and its practical applications, to thereby enable those having ordinary skill in the art to utilize the disclosure and various embodiments with various modifications as are suited to the particular use contemplated.

### REFERENCE LIST

1 vehicle
2 wall
4 guiding rail
6 sealing
10 sliding door
12 counter coupling element
100 actuating apparatus
110 rotating mechanism
112 driving element
114 rotational axis
116 direction of rotational movement
120 motor
130 gearbox
140 locking mechanism
142 locking element
144 actuator
150 detection device
160 detection device
170 controlling circuitry
200 method
210-220 method step(s)

1. An actuating apparatus for a sliding door, the actuating apparatus comprising:
a motor-driven rotating mechanism comprising a driving element arranged to be selectively moved between a first position and a second position upon rotation of the motor-driven rotating mechanism,
wherein the driving element is configured to be selectively coupled with or decoupled from a counter coupling element of the sliding door when in the first position, and
wherein the driving element is configured to drive the counter coupling element coupled therewith upon rotation of the motor-driven rotating mechanism from the first position to the second position, and
wherein the second position corresponds to a closing position or locking position of the sliding door.

2. The actuating apparatus of claim 1, wherein the motor-driven rotating mechanism is self-locking at least in the second position.

3. The actuating apparatus of claim 1, further comprising a self-locking gearbox coupled to the motor-driven rotating mechanism and configured to restrict rotation thereof at least in a direction of the first position.

4. The actuating apparatus of claim 1, further comprising a locking mechanism configured to be selectively coupled to the motor-driven rotating mechanism in at least the second position to restrict rotation thereof at least in a direction of the first position.

5. The actuating apparatus of claim 1, further comprising a controlling circuitry configured to control the rotation of the motor-driven rotating mechanism.

6. The actuating apparatus of claim 5, wherein the controlling circuitry is further configured to receive a first detection signal indicating at least a presence of the counter coupling element at the driving element and generate, based on the first detection signal, a first control signal configured to control the motor-driven rotating mechanism to rotate.

7. The actuating apparatus of claim 5, wherein the controlling circuitry is further configured to receive a second detection signal indicating that the driving element has reached the second position and generate a second control signal configured to control the motor-driven rotating mechanism to stop rotating.

8. The actuating apparatus of claim 5, wherein the controlling circuitry is further configured to generate a third control signal configured to control a locking mechanism to lock the motor-driven rotating mechanism such as to restrict rotational movement thereof.

9. The actuating apparatus of claim 1, further comprising at least one detection device configured to detect at least one of at least a presence of the counter coupling element at the driving element and the driving element at the second position.

10. The actuating apparatus of claim 1, wherein the driving element is configured to open towards a peripheral side or outer side of the motor-driven rotating mechanism when in the first position to selectively receive the counter coupling element for coupling and release the counter coupling element for decoupling.

11. The actuating apparatus of claim 1, wherein the motor-driven rotating mechanism comprises: a rotatable gear element drivable by a motor and the driving element at a peripheral section thereof.

12. A sliding door arrangement, comprising:
a sliding door comprising a counter coupling element; and
an actuating apparatus comprising:
a motor-driven rotating mechanism comprising a driving element arranged to be selectively moved between a first position and a second position upon rotation of the motor-driven rotating mechanism,
wherein the driving element is configured to be selectively coupled with or decoupled from a counter coupling element of the sliding door when in the first position, and
wherein the driving element is configured to drive the counter coupling element coupled therewith upon the rotation of the motor-driven rotating mechanism from the first position to the second position, and
wherein the second position corresponds to a closing position or locking position of the sliding door.

13. The sliding door arrangement of claim 12, further comprising a guiding rail configured to guide the sliding door and the counter coupling element and configured to open towards the driving element positioned in the first position.

14. A vehicle comprising:
a sliding door comprising a counter coupling element; and
an actuating apparatus comprising:
a motor-driven rotating mechanism comprising a driving element arranged to be selectively moved between a first position and a second position upon rotation of the motor-driven rotating mechanism,
wherein the driving element is configured to be selectively coupled with or decoupled from a counter coupling element of the sliding door when in the first position, and
wherein the driving element is configured to drive the counter coupling element coupled therewith upon the rotation of the motor-driven rotating mechanism from the first position to the second position, and
wherein the second position corresponds to a closing position or locking position of the sliding door.

15. A method of actuating a sliding door, the method comprising:
receiving a first detection signal indicating at least a presence of a counter coupling element of the sliding door at a driving element of a rotating mechanism being in a first position, wherein the driving element and the counter coupling element are selectively coupled with or decoupled from each other; and
generating, based on the first detection signal, a first control signal configured to control the rotating mechanism to rotate for moving the driving element and the counter coupling element coupled therewith to a second position, wherein the second position corresponds to a closing position or locking position of the sliding door.

16. The method of claim 15, further comprising:
receiving a second detection signal indicating that the driving element has reached the second position, and
generating a second control signal configured to control the rotating mechanism to stop rotating.

17. The method of claim 15, further comprising generating a third control signal configured to control a locking mechanism to lock the rotating mechanism to restrict rotational movement thereof.

18. A computer program comprising instructions to cause an actuation apparatus to:
receive a first detection signal indicating at least a presence of a counter coupling element of a sliding door at a driving element of a rotating mechanism of the actuation apparatus being in a first position, wherein the driving element and the counter coupling element are selectively coupled with or decoupled from each other; and
generate, based on the first detection signal, a first control signal configured to control the rotating mechanism to rotate for moving the driving element and the counter coupling element coupled therewith to a second position, wherein the second position corresponds to a closing position or locking position of the sliding door.
